(19) United States
(12) Patent Application Publication
(10) Pub. No.: US 2015/0115592 A1
(43) Pub. Date: Apr. 30, 2015

(54) Reference System and Method for Fiber Optic Cables

(71) Applicant: Kristopher Garcia, Appleton, WI (US)

(72) Inventor: Kristopher Garcia, Appleton, WI (US)

(21) Appl. No.: 14/066,801

(22) Filed: Oct. 30, 2013

(51) Int. Cl. B42D 12/00

(52) U.S. Cl. CPC B42D 12/00
USPC 283/67; 283/66.1

(57) ABSTRACT

A system of color coded reference tables is disclosed by which fiber optic installation workers and engineers may quickly and easily convert fiber count numbers to bundle and sheath colors. The color code used may be an industry-standard 12-color or an alternative mapping of colors to numbers. The tables convert a numerical cable count having in principal no upper bound to an identifiable color code, which may be applied to cables and related equipment in the field. The tables of the system may be printed on a laminated card or page where an installation worker may make temporary notations using a solvent-erase marker (for example to check off fibers for which work has been completed).

### CROSS-REFERENCE TO RELATED APPLICATIONS

Not Applicable

### STATEMENT REGARDING FEDERALLY SPONSORED RESEARCH OR DEVELOPMENT

Not Applicable

### PARTIES TO A JOINT RESEARCH AGREEMENT

Not Applicable

### REFERENCE TO SEQUENCE LISTING, A TABLE, OR A COMPUTER PROGRAM LISTING COMPACT DISK APPENDIX

Not Applicable

### BACKGROUND OF THE INVENTION

The invention relates generally to the field of fiber optic installation systems and methods, and in particular to reference systems for correctly splicing and terminating fiber optic cables and methods of applying said reference systems.

Conventionally, fiber optic cables comprise a cable sheath surrounding a plurality of cable bundles, each surrounding a plurality of individually coated fibers. Under one standard in common use, groups of 12 fibers are sheathed together into bundles, and groups of up to 12 bundles are sheathed together into cables of up to 144 fibers. Under the same standard, each fiber and bundle is given an index between 1 and 12, identified by the following color table:

TABLE 1

| Index | Color |
|---|---|
| 1 | Blue |
| 2 | Orange |
| 3 | Green |
| 4 | Brown |
| 5 | Slate |
| 6 | White |

TABLE 2

| Index | Color |
|---|---|
| 7 | Red |
| 8 | Black |
| 9 | Yellow |
| 10 | Violet |
| 11 | Rose |
| 12 | Aqua |

Since both fibers and bundles have the same color codes, each fiber in a cable may be uniquely identified by both its count number (an index from 1 to n, where n is the number of fibers in an entire cable) and the colors of its sheath and bundle. For example, fiber count number 1 (1st bundle, 1st fiber) refers to the blue sheathed fiber in the blue bundle. For another example, fiber count number 38 (4th bundle, 2nd fiber) refers to the orange sheathed fiber in the brown sheathed bundle; the number 38 is calculated by multiplying 4, the count of the bundle, by 12, the number of bundles for a product of 36, and adding 2 for a sum of 38, the count of the fiber within the bundle.

Conventionally, fiber optic installation workers must rely on mental arithmetic, hand counting, or written notes to work out a conversion from fiber count number to bundle and sheath colors, or vice versa. This is time consuming and generally carries a high risk of human error. The same problem applies when a worker is working on a patch panel (e.g. for testing a fiber optic installation) because fiber optic patch panels typically are arranged in 144-fiber blocks, just as cables are. When a worker wants to locate a fiber on the patch panel, he must locate the desired fiber using one of the same methods needed to identify a fiber within a cable.

Further, when site engineers design a telecom system for a site, it is convenient for them to assign cable numbers to buildings or locations without regard to the fibers' bundling within the cable. Oftentimes, it is necessary for installation workers in the field to re-engineer count number assignments in the field in order to prevent multiple fibers for one location from having to come from different bundles within a cable. When these re-designs occur, the result is wasted time and worker hours.

Under this or similar systems, it is possible to pinpoint every fiber by its sheath color or bundle color, but these systems do not scale well. The color code sequence stops at 12. Since it is used for both dimensions of the index, it is optimal for cables having 144 fibers or fewer. When more than 144 fibers are present, alternatives must be found. For example, some manufacturers of 288 fiber cables differentiate a first set of 12 bundles from a second set by marking one set with a black line on top of the usual colored sheaths while leaving the colored sheaths of the other set unmarked. Some immediately apparent solutions, such as using a longer color code sequence (e.g. 14 colors, 16 colors) and correspondingly increasing the number of fibers per bundle or bundles per cable, or adding additional patterns (e.g. dotted lines, cross-hatched lines) to increase the number of sets of 12 bundles, would quickly become impractical.

Twelve is already a large number of colors for a worker to visually differentiate (leaving aside the limitations faced by otherwise able and healthy installation workers who are colorblind). Adding more colors would increase the difficulty of differentiating the colors, particularly in low-light conditions, where many cables may be installed. Similarly, adding additional patterns to the outsides of bundles in cables having more than 144 fibers would likewise be confusing to installation workers and lead to increased human error which, as discussed in the examples above, is already a serious problem in the field of fiber optic installation. Moreover, these above apparent solutions involve changing well-established industry standards for fiber optic sheath coloring.

A preferable solution would comprise an effective reference system to allow fiber optic installation workers and site engineers to obtain the necessary information about the cable that they are working with in a more efficient manner. It is to such a system that the invention pertains.

### SUMMARY OF THE INVENTION

Accordingly, the invention is directed to a system of color coded reference tables by which fiber optic installation workers and engineers may quickly and easily convert fiber count numbers to bundle and sheath colors. The color code used may be an industry-standard 12-color or an alternative mapping of colors to numbers. The tables convert a numerical cable count having in principal no upper bound to an identifiable color code, which may be applied to cables and related equipment in the field. The tables of the system may be printed on a laminated card or page where an installation worker may make temporary notations using solvent-erase marker (for example to check off fibers for which work has been completed).

The system is effective even when very large cables or combinations of cables are involved in an installation. The system is adaptable to easily mark or identify unlabeled equipment such as patch panels and the external sheaths of multiple cables. The system may be adapted to any standard of manufacture for sheath and bundle colors in fiber optic cables. It is an object of the invention to improve the efficiency of fiber optic installation workers by eliminating the need for them to hand count or otherwise work out which fiber within a cable having hundreds of fibers is the correct fiber.

It is an object of the invention to reduce human error in the fiber optic installation process by reducing the mental effort required to convert fiber count number to bundle and sheath color.

It is an object of the invention to improve the ability of fiber optic site engineers to avoid suboptimal count number assignments to locations by allowing them to work out the arrangement of fibers in a cable without having to examine a physical cable.

Additional features and advantages of the invention will be set forth in the description which follows, and will be apparent from the description, or may be learned by practice of the invention. The foregoing general description and the following detailed description are exemplary and explanatory and are intended to provide further explanation of the invention.

### BRIEF DESCRIPTION OF THE DRAWINGS

The accompanying drawings are included to provide a further understanding of the invention and are incorporated into and constitute a part of the specification. They illustrate one embodiment of the invention and, together with the description, serve to explain the principles of the invention.

FIG. 1 shows the first table of the first exemplary embodiment, showing the bundle labels 10, the sheath color list 11, 12×12 matrix 12, and example reference numeral 13.

FIG. 2 shows the second table of the first exemplary embodiment, displaying the sheath color list 11, bundle labels 20, and 12×12 matrix 22.

FIG. 3 shows the third table of the first exemplary embodiment, displaying the sheath color list 11, bundle labels 30, and 12×12 matrix 32.

FIG. 4 shows the fourth table of the first exemplary embodiment, displaying the sheath color list 11, bundle labels 40, and 12×12 matrix 42.

FIG. 5 shows the fifth table of the first exemplary embodiment, displaying the sheath color list 11, bundle labels 50, and 12×12 matrix 52.

FIG. 6 shows the sixth table of the first exemplary embodiment, displaying the sheath color list 11, bundle labels 60, and 12×12 matrix 62.

FIG. 7 shows the seventh table of the first exemplary embodiment, displaying the sheath color list 11, bundle labels 70, and 12×12 matrix 72.

FIG. 8 shows the eighth table of the first exemplary embodiment, displaying the sheath color list 11, bundle labels 80, and 12×12 matrix 82.

FIG. 9 shows the first side of the first exemplary embodiment, as a card, displaying the sheath color list 11, first side of the card 90, first table 91, second table 92, third table 93, and fourth table 94.

FIG. 10 shows the second side of the first exemplary embodiment, as a card, displaying the sheath color list 11, second side of the card 91, fifth table 101, sixth table 102, seventh table 103, and eighth table 104.

FIG. 11 shows the second exemplary embodiment, displaying the first set of bundle labels 110, second set of bundle labels 111, first 12×12 matrix 112, and second 12×12 matrix 113.

### DETAILED DESCRIPTION OF THE INVENTION

Referring now to the invention in more detail, the invention is directed to a reference system for fiber optic cables that allow fiber optic installation workers and others, such as site engineers, who are involved in fiber optic installation to readily convert a particular fiber's numeric index (“count number”) to the color of its sheath and that of the bundle in which it is contained. The system is adaptable to any current or future standard of color codes for fiber optic sheaths and bundles of fibers within the cables. Of course, the system may be readily adapted generally to any system of conduits, whether made of fiber optics, metal wires, or other material and whether it is for data transmission or some other purpose, so long as the conduits are color coded or pattern coded.

The below examples use the 12-color system in common use today described below, however the tables and charts shown in the figures can readily be rewritten for different sequences and numbers of colors and/or visual patterns of 2 or more colors, with the only requirements being that the same number and set of colors or patterns is used both for the fiber sheath and bundle sheath. In order to allow the system to scale, the same color sequence may be used to describe an ordering of multiple cables or multiple sets of 12 bundles within a single very large cable. The particular colors used are as follows:

TABLE 3

| Index | Color |
|---|---|
| 1 | Blue |
| 2 | Orange |
| 3 | Green |
| 4 | Brown |
| 5 | Slate |
| 6 | White |

TABLE 4

| Index | Color |
|---|---|
| 7 | Red |
| 8 | Black |
| 9 | Yellow |
| 10 | Violet |
| 11 | Rose |
| 12 | Aqua |

This color sequence allows a particular fiber to be identified both by its count number and by the color of its sheath and bundle. In general, where n is the fiber's count number, and where b is the bundle index and i is the fiber's index within its bundle, b is equal to n/12 rounded up to the next integer, and i is equal to the remainder of n/12. Thus, the fiber with count number 91 has a bundle index of 8 (count numbers 85-96) and a fiber index of 6 (the sixth fiber in the bundle), so it is readily identified as the white-sheathed fiber inside of the black-sheathed bundle.

Within each 144-fiber cable, this color index is unique. To extend beyond 144 fibers, each set of 144 fibers may further be assigned a color within the 12-color system. Some large cables containing more than 144 fibers or more than 12 bundles may be manufactured with colored groupings of 12 bundles each, either by designating these groupings with their own colored sheath or with distinctive patterns, such as a black line in the bundle sheath. In cases where sequential groups of 144 fibers or 12 bundles are not so differentiated, for example where several cables are run together to provide multiple sets of fibers, or where fibers are connected to undifferentiated patch panels, the undifferentiated equipment may be marked, for example with colored tape, grease markers, etc. in accordance with the 12-color system or other system. In furtherance of the use of the invention, a specialized set of markers or tapes may be provided in the appropriate range of colors for marking this undifferentiated equipment.

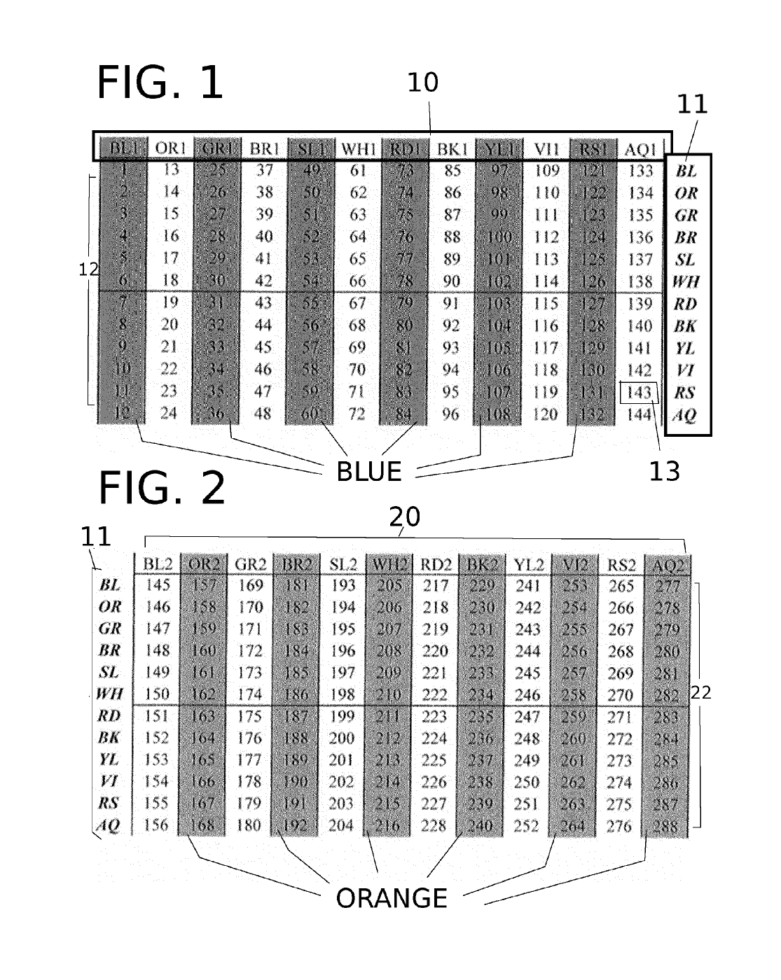

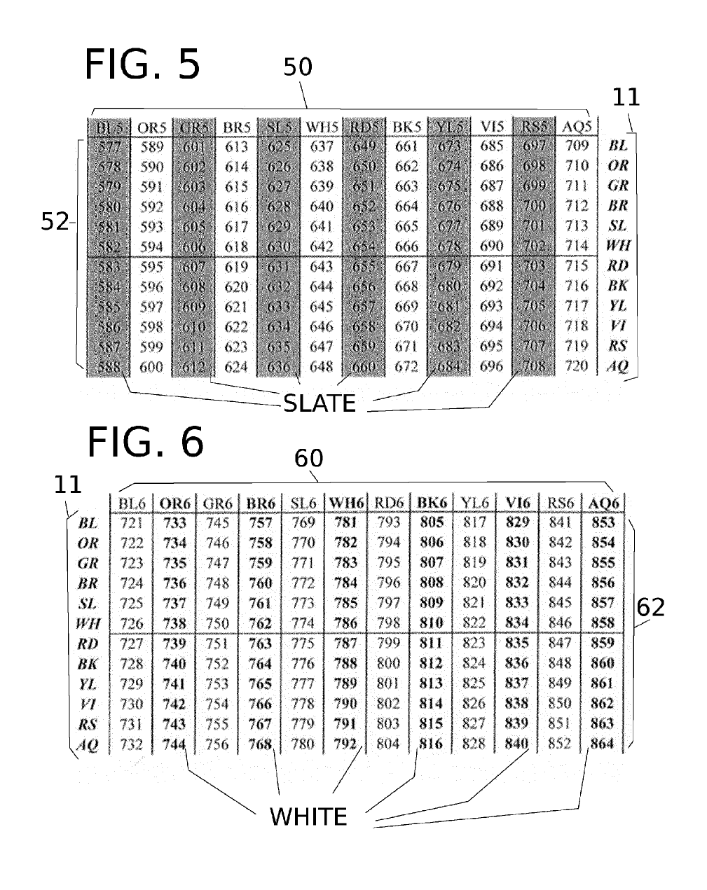

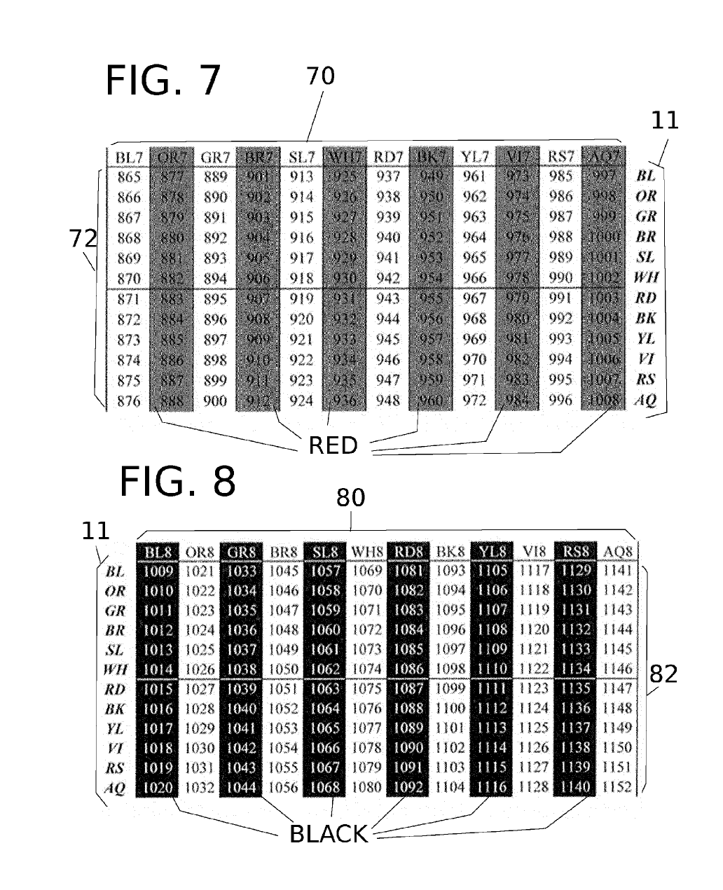

In order to overcome the above inefficiencies and error risks associated with hand counting to convert between count number and bundle and sheath color, and vice versa, the invention comprises the provision of a chart or table. The chart or table is dimensioned in accordance with the particular color system employed, for example, series of 12×12 matrices may be used for the 12-color system herein described. The first exemplary embodiment is one such table, and different views of it are shown in FIGS. 1-10.

Referring now to the first exemplary embodiment, FIG. 1 shows the first table. In the first table, a list of bundle labels 10 is presented horizontally across the top. The bundle labels 10 are designated with abbreviations of each of the colors in the system, followed by a “1” to indicate that this table refers to the 1st set of 12 bundles. The abbreviations used in the first exemplary embodiment are as follows: blue=“BL”; orange=“OR”; green=“GR”; brown=“BR”; slate=“SL”; white=“WH”; red=“RD”; black=“BK”; yellow=“YL”; violet=“VI”; rose=“RS”; aqua=“AQ”. Other embodiments may use different systems of abbreviation or may present unabbreviated color names, or may eschew printing the names of the colors entirely and print only the colors. Also, a list of sheath color list 11 using the same abbreviations, however without an index number is presented vertically down either side (here, the right). Inside of the table is a 12×12 matrix 12 of figures. The figures are sequential numbers that increment down each column, columns from left to right. In other embodiments, the rows and columns may be arranged differently, for example in embodiments for use in locales where people customarily read right to left, the column order may be reversed. Also, the invention may be practiced reversing the rows and columns of each table.

To read the table, consider an example reference numeral 13, which indicates count number 143. According to the chart, count number 143 indicates the rose-sheathed fiber in the aqua-sheathed bundle. Since FIG. 1 shows the first table with bundle labels 10 having an index of 1, the example FIG. 13 with count number 143 refers to the rose-sheathed fiber in the aqua-sheathed bundle in the first set of 144 fibers or 12 bundles. In the first exemplary embodiment, alternating columns of the charts are given color highlighting (a well understood means for visually differentiating rows or columns in tabular data). In FIG. 1, the color highlight is blue, which corresponds to the number 1 in the color code system. Thus, when large cables or multiple cables are used, the blue highlighting visually identifies the first table of FIG. 1 as referring to the first or blue set of 12 bundles or 144 fibers. Depending on the particular equipment used, sets of 12 bundles or 144 fibers may be identified by color or number, or both. Where necessary, the text of the highlighted columns may be printed in a contrasting color other than the color of the text of the highlighted columns; for example where black text is used predominantly, the black text may have poor contrast with the brown highlighting of the fourth table 12×12 matrix 42, and so in that case the text of the fourth table 12×12 matrix 42 may be printed in white or another color contrasting with brown.

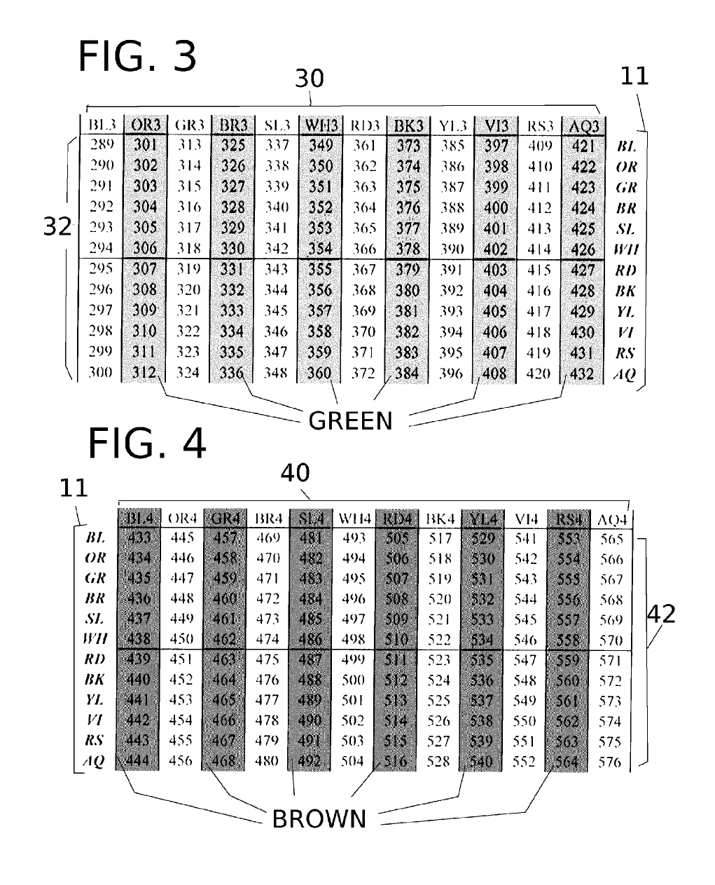

Referring still to the first embodiment, FIG. 2 shows the second table. In the second table, a list of bundle labels 20 identifies the bundles of the second set of 12 bundles or 144 fibers. The sheath color list 11 is the same list used in the first table. Thus the 12×12 matrix 22 shows the count number to bundle and sheath color conversion for the second set, and correspondingly the column highlights of the table are orange for 2 in the color code system. Similarly, FIGS. 3-8 show additional tables of the first exemplary embodiment along the same progression, with each table having a 12×12 matrix that identifies ever larger count numbers and relates them to bundle and sheath colors. The first exemplary embodiment provides for 8 tables with count numbers up to 1,152 (144×8). The system as described, however, provides for up to 12 tables with count numbers up to 1,728 (144*12 or 12³), which may be used as a reference for installations having very large numbers of fibers. For installations having more than 1,728 fibers, the system may be repeated by applying the color code to sets of 1,728 or 12³ fibers. Thus, the system may be expanded for 12×12⁴ or 20,736 fibers. Should 20,736 fibers be insufficient for an extremely large installation, the system may be expanded and repeated for each power of 12, as necessary.

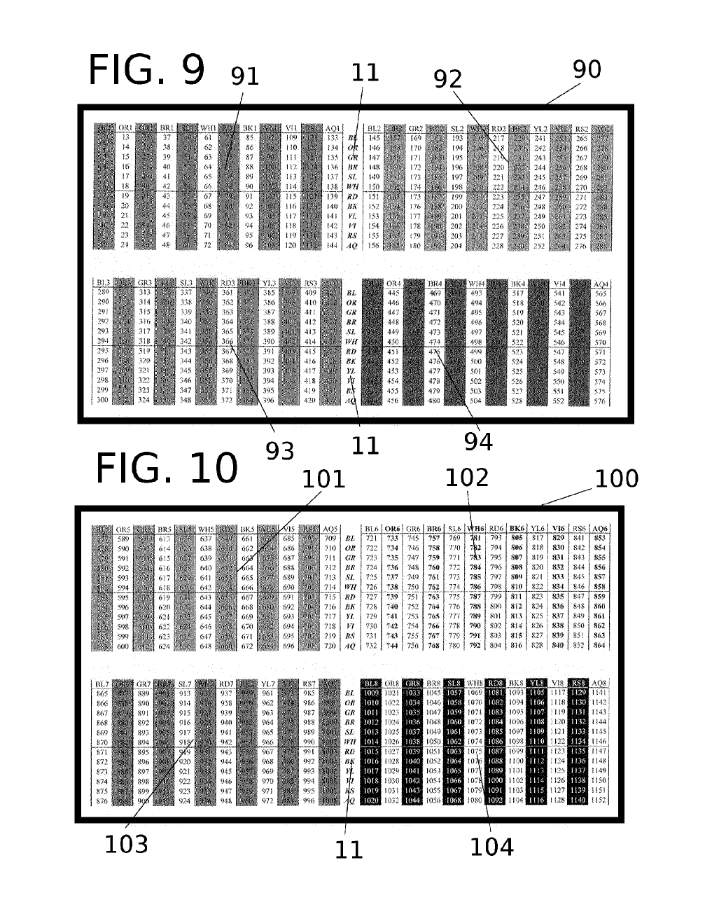

Referring still to the first exemplary embodiment, for real world use by fiber optic installation workers or site engineers, etc., the tables may be printed in color on a card or page. FIG. 9 and FIG. 10 show the first exemplary embodiment printed on one such card or page. On the first side of the page 90 may be found in a top row the first table 91 and second table 92, which share one sheath color list 11. In a bottom row may be found the third table 93 and fourth table 94, which share another sheath color list 11. On the second side of the page 100 may be found in a top row the fifth table 101 and sixth table 102 which share a single sheath color list 11, and on a bottom row may be found the seventh table 103 and eighth table 104, which share a single sheath color table 11.

The card or sheet may be laminated or coated, preferably with a sturdy and transparent coating material that does not dissolve with common industrial solvents, such as ethanol or acetone. Since the card or sheet is to be used as reference by works in the field, indestructibility is desirable. Non-solubility with ethanol or similar solvents is desirable to allow workers to annotate the reference (for example, to mark off fibers for which work has been completed) with permanent marker, and then erase the markings after work is complete using the aforementioned solvents. It is preferable to mark in permanent marker (erasable with an industrial solvent such as ethanol) because more readily erasable means, such as dry erase markers, are likely to be inadvertently erased as the reference card or sheet is handled and carried around. Industrial grade ethanol is a particularly preferable solvent for use on fiber optic sites because crews generally have it on hand for its application in cleaning fibers to be spliced.

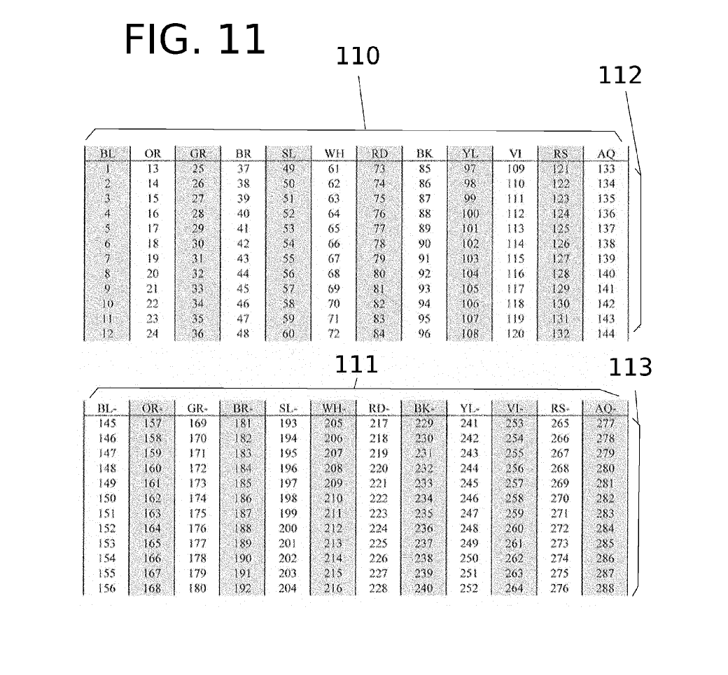

Referring now to the second exemplary embodiment, certain cables have been produced with more than 144 fibers, for example 288 fibers, and have identified the different sets of bundle sheaths not with differentiated colors, but with patterns, such as a black line on top of the existing colors for one set of bundles, but not the other. FIG. 11 shows a pair of tables adapted for such a 288-fiber cable. In the second exemplary embodiment, a first table is provided having a first set of bundle labels 110 horizontally across the top and a 12×12 matrix 112 of sequential integers from 1 to 144 that increment down each column, columns from left to right. A second table is also provided having a second set of bundle labels 111 horizontally across the top and a 12×12 matrix 113 of sequential integers from 1 to 144 that increment down each column, columns from left to right.

Referring still to the second exemplary embodiment, the first bundle labels 110 give no additional index information, while the second bundle labels 111 indicates a dash (“-”) after each bundle color abbreviation. The dash indicates that the listing corresponds to the bundle having been manufactured with a line on its sheath, as opposed to the bundle of the same color also present in the cable but not having such a line. The tables of the second exemplary embodiment have highlighted columns, but because the intended cable is limited to 288 fibers, the column highlight color of the second exemplary embodiment does not matter because it does not encode any information. Further, it should be noted that the second exemplary embodiment as shown lacks a sheath color list 11; the sheath color list 11 may be omitted from any table of the invention and the user's memorization of the color or pattern code sequence relied upon to establish individual sheath counts.

While the foregoing written description of the invention enables one of ordinary skill to make and use what is presently considered to be the best mode thereof, those of ordinary skill in the art will understand and appreciate the existence of variations, combinations, and equivalents of the specific embodiment, method, and examples herein. The invention should, therefore, not be limited by the above described embodiment, method, and examples, but by all embodiments and methods within the scope and spirit of the invention.

I claim:

1. A reference system comprising:
(a) a color or pattern code system comprising the association of a plurality of n colors with n designated numerical indices;
(b) said color or pattern code system being applied to a plurality of conduits and to a plurality of bundles of n conduits, and also to any number of higher order pluralities of bundles of n conduits, such that each conduit may be given a unique numerical count determined by its color or pattern and the colors or patterns of all of the bundles containing it, according to said color or pattern code system;
(c) said color or pattern code system being applied to generate at least one table;
(d) each of said at least one table comprising an n-by-n matrix;
(e) said n×n matrix being filled with sequential numbers, each corresponding to a conduit count, and positioned in order along each column or each row of said n×n matrix;
(f) each of said at least one table comprising a set of bundle labels;
(g) said set of bundle labels being positioned adjacent to said n×n matrix such that each of said set of bundle labels functions as a header of one column or one row of said n×n matrix containing sequential conduit counts;
(h) each of said set of bundle labels designating one color or pattern of said color or pattern code system and an index identifier designating the particular count of said at least one table in which the particular one of said set of bundle labels is located; and
(i) each set of n of said sequential numbers with one column or one row of said n×n matrix being mapped to said color or pattern code system.

2. The reference system of claim 1 further comprising a sheath color or pattern list, said sheath color or pattern list comprising an ordered set of identifiers, each designating one color or pattern of said color or pattern code system; said sheath color or pattern list being positioned adjacent to said n×n matrix such that each of said ordered set of identifiers functions as a header of one row or one column of said n×n matrix containing n conduit counts each corresponding to a conduit having the same sheath color or pattern as the particular one of said set of ordered identifiers as heads the particular row or column in which it is located.

3. The reference system of claim 1 wherein alternating columns or rows of said n×n matrix highlighted with a highlight color or pattern, such that highlighting is applied only to columns or rows of said n×n matrix that contain sequential conduit counts.

4. The reference system of claim 3 wherein said highlight color or pattern is a selected color or pattern from said color or pattern code system such that said selected color or pattern is associated with the particular index number of said set of bundle labels

5. The reference system of claim 2 wherein alternating columns or rows of said n×n matrix highlighted with a highlight color or pattern, such that highlighting is applied only to columns or rows of said n×n matrix that contain sequential conduit counts.

6. The reference system of claim 5 wherein said highlight color or pattern is a selected color or pattern from said color or pattern code system such that said selected color or pattern is associated with the particular index number of said set of bundle labels.

7. The reference system of claim 6 wherein alternating columns or rows of said n×n matrix highlighted with a highlight color or pattern, such that highlighting is applied only to columns or rows of said n×n matrix that contain sequential conduit counts, and wherein said highlight color or pattern is a selected color or pattern from said color or pattern code system such that said selected color or pattern is associated with the particular index number of said set of bundle labels.

8. The reference system of claim 1 wherein said conduits are fiber optic cables.

9. The reference system of claim 1 wherein said color or pattern code system is a 12-color code system wherein: blue=1, orange=2, green=3, brown=4, slate=5, white=6, red=7, black=8, yellow=9, violet=10, rose=11, and aqua=12, and wherein n=12.

10. The reference system of claim 7 wherein said conduits are fiber optic cables, wherein said color or pattern code system is a 12-color code system wherein: blue=1, orange=2, green=3, brown=4, slate=5, white=6, red=7, black=8, yellow=9, violet=10, rose=11, and aqua=12, and wherein n=12.

11. The reference system of claim 10 wherein said plurality of conduits comprises a plurality of 144-count fiber optic cables each divided into 12 bundles of 12 fibers, and wherein the sheath of each of said fibers, each of said bundles, and each of said cables is colored according to said 12-count color code, and wherein each of said 144-count bundles corresponds to one of said at least one table.

12. The reference system of claim 3 wherein said conduits are fiber optic cables, wherein said color or pattern code system is a 12-color code system wherein: blue=1, orange=2, green=3, brown=4, slate=5, white=6, red=7, black=8, yellow=9, violet=10, rose=11, and aqua=12, and wherein n=12.

13. The reference system of claim 12 wherein said plurality of conduits comprises a 288-count fiber optic cable divided into 2 144-count bundles of 144 fiber optic cables, each divided into 12 12-count bundles of 12 fibers, and wherein each of said 12-count bundles, and each of said cables is colored according to said 12-count color code system, except that those of said 12-count bundles belonging to the second 144-count bundle is colored with a black stripe, and wherein each of said 144-count bundles corresponds to one of said at least one table, and wherein the particular one of said at least one table that designates the second of said 2 144-count bundles use a dash symbol for said index identifier.

14. The reference system of claim 1 wherein said at least one table is printed on a physical printing medium.

15. The reference system of claim 14 wherein said physical printing medium is a card having an exterior surface material that is suitable for marking upon using a permanent marker and erasing with a solvent.

16. A method of using the reference system of claim 15 comprising distributing a plurality of copies of copies of said physical printing medium to at least one of the group of site engineers and installation workers at a fiber optic installation site, and training said site engineers and fiber optic installation workers to convert fiber counts to sheath colors and vice versa by referencing said one or more tables to the exclusion of performing mental arithmetic and hand counting.

17. The method of claim 16 further comprising applying said color or pattern code system to unmarked equipment that interfaces with said conduits.

18. The reference system of claim 10 wherein said at least one table is printed on a physical printing medium; and wherein said physical printing medium is a card having an exterior surface material that is suitable for marking upon using a permanent marker and erasing with a solvent; and further comprising a method of using said reference system comprising distributing a plurality of copies of copies of said physical printing medium to at least one of the group of site engineers and installation workers at a fiber optic installation site, training said site engineers and fiber optic installation workers to convert fiber counts to sheath colors and vice versa by referencing said one or more tables to the exclusion of performing mental arithmetic and hand counting, and applying said color or pattern code system to unmarked equipment that interfaces with said conduits.

19. The reference system of claim 11 wherein said at least one table is printed on a physical printing medium; and wherein said physical printing medium is a card having an exterior surface material that is suitable for marking upon using a permanent marker and erasing with a solvent; and further comprising a method of using said reference system comprising distributing a plurality of copies of copies of said physical printing medium to at least one of the group of site engineers and installation workers at a fiber optic installation site, training said site engineers and fiber optic installation workers to convert fiber counts to sheath colors and vice versa by referencing said one or more tables to the exclusion of performing mental arithmetic and hand counting, and applying said color or pattern code system to unmarked equipment that interfaces with said conduits.

20. The reference system of claim 13 wherein said at least one table is printed on a physical printing medium; and wherein said physical printing medium is a card having an exterior surface material that is suitable for marking upon using a permanent marker and erasing with a solvent; and further comprising a method of using said reference system comprising distributing a plurality of copies of copies of said physical printing medium to at least one of the group of site engineers and installation workers at a fiber optic installation site, training said site engineers and fiber optic installation workers to convert fiber counts to sheath colors and vice versa by referencing said one or more tables to the exclusion of performing mental arithmetic and hand counting, and applying said color or pattern code system to unmarked equipment that interfaces with said conduits.
